(19) United States
(12) Patent Application Publication
(10) Pub. No.: US 2009/0278494 A1
(43) Pub. Date: Nov. 12, 2009

(54) Universal electrical interface for providing power to mobile devices

(76) Inventor: Mitch Randall, (US)

Correspondence Address: COCHRAN FREUND & YOUNG LLC, 2026 CARIBOU DR, SUITE 201, FORT COLLINS, CO, 80525, US

(21) Appl. No.: 12/380,893

(22) Filed: Mar. 3, 2009

Related U.S. Application Data
(60) Provisional application No. 61/033,223, filed on Mar. 3, 2008.

(51) Int. Cl. H02J 7/00

(52) U.S. Cl. 320/114

(57) ABSTRACT

A charging system that comprises circuitry adapted to devices to be charged, including a power receiver module embedded in or molded into a form-fit case, e.g., gel-skin, that attaches physically and electrically to the device to be charged and that effectively receives power conductively from a power delivery surface of a recharging pad on which the devices are placed. An embodiment may include a method or device whereby a simplified, common interface provides power to mobile devices via electrical contact for a range of positions and orientations of the mobile device. In some embodiments, the range of positions may be automatically partially constrained mechanically such that power is transferred for all possible remaining orientations.

### CROSS-REFERENCES TO RELATED APPLICATIONS

This application is a non-provisional application based upon and claims priority to U.S. provisional application Ser. No. 61/033,223 filed Mar. 3, 2008, entitled “Universal Electrical Interface for Providing Power to Mobile Devices,” which is specifically incorporated herein by reference for all that it discloses and teaches.

### BACKGROUND OF THE INVENTION

1. Field of the Invention

The present invention relates to electronic systems and methods for providing electrical power and/or data to one or more electronic or electrically powered devices with a power delivery surface.

2. State of the Prior Art

A variety of electronic or electrically powered devices, such as toys, game devices, cell phones, laptop computers, cameras, and personal digital assistants, have been developed along with ways for powering them. Mobile electronic devices typically include, and are powered by, batteries, which are rechargeable by connecting the batteries through power cord units to a power source. Power cord units typically include transformers and/or power converters connected to a power source such that the transformers and/or power converters condition the power supplied to the mobile electronic device. Typical power sources include, but are not limited to, an electric wall outlet, a connection to the power grid, and/or an automobile or other vehicle accessory electric outlet plug receptacle or the like. A mobile electronic device may typically be connected to the power source through the power cord unit either during use of the electronic device and/or between uses. A non-mobile electronic device is generally one that is powered through a power cord unit and is not intended to be moved during use any farther than the reach of the power cord, so the non-mobile electronic device generally does not have, or need, batteries for powering the device between plug-ins to the power source.

In a typical set-up for a mobile device, the power cord unit includes an outlet connector or plug for connecting it to the power source and a battery connector for connecting it to a corresponding battery power receptacle of the battery. The outlet connector or plug and battery connectors are typically in connected with each other such that electrical power may flow from the power source to the battery, and in some limited instances from the battery to the power source. The power source charges the battery through the power cord unit via the electrical connection between the power source and the battery.

In some setups, the power cord unit may include a power adapter, transformer, or converter connected to the outlet and battery connectors through AC (Alternating Current) input and DC (Direct Current) output cords, respectively. The power adapter typically adapts an AC input voltage received from the power source through the outlet connector and AC input cord to output a DC voltage through the DC output cord. Other setups include adapters, transformers, or converters connected to the outlet and battery connectors through DC input and DC output cords. The DC output current flows through the battery power receptacle and is used to charge the battery.

Manufacturers, however, many times make their own models of electronic devices and do not make their power cord unit compatible with the electronic devices of other manufacturers, or with other types of electronic devices. As a result, a battery connector made by one manufacturer may not fit into the battery power receptacle made by another manufacturer. Further, a battery connector made for one type of device typically will not fit into the battery power receptacle made for another type of device. Further, even in instances where interchangeable connectors are used by different manufacturers, the electrical characteristics/power requirements may differ from other manufacturers devices, such as having different DC input voltages required at the battery power receptacle. Manufacturers make the power cord unit connectors unique to their own devices for several reasons, such as cost, liability concerns, different power requirements, and to acquire or hold a market share.

However, the proliferation of unique power cords that are not compatible with other devices can be troublesome for consumers because they have to buy unique power cord units for their particular electronic devices and deal with the plethora of different power cords required for their devices. Since people tend to switch devices often, it is inconvenient, expensive, and wasteful for them to also have to switch power cord units as well. Unfortunately, power cord units that are no longer useful are often discarded, which is also wasteful and harmful to the environment. Further, people generally own a number of different types of electronic devices and owning a power cord unit for each device is inconvenient because the consumer must deal with a large quantity of power cord units and the confusion and tangle of power cords the situation creates.

### BRIEF DESCRIPTION OF THE DRAWINGS

The accompanying drawings, which are incorporated in and form a part of the specification, illustrate example implementations of the present invention, but not the only ways the invention can be implemented, and together with the written description and claims, serve to explain the principles of the invention.

In the drawings:

FIG. 1 is a perspective view of a wireless charging pad and a mobile device being placed on the wireless charging pad.

FIG. 2 is an enlarged perspective view of a wireless charging pad showing an array of alternately positively and negatively charged contact strips.

FIG. 3 is an enlarged bottom view of an enabled mobile device showing multiple contact points arranged in a contact pattern.

FIG. 4 is a schematic diagram of a four-way bridge rectifier for properly obtaining the correct electrical connection for a mobile device with four contact points.

FIG. 5 is a block diagram of a charging system having a wireless charging pad with alternating conducting strips and a mobile device with many contact points arranged in a contact pattern.

FIG. 6 is a perspective view of a simplified wireless power interface embodiment that uses partial mechanical constraints to orient a mobile device.

FIG. 7 is a bottom view of an example power receiving device with two contact points for connection to a simplified wireless power interface.

FIG. 8 is a side view of a mobile device resting on a simplified wireless power interface support surface.

FIG. 9 is a schematic diagram of a simple circuit for deriving power from a simplified wireless power interface.

FIG. 10 is a schematic diagram of a safety circuit for protecting a mobile device deriving power from a simplified wireless power interface.

FIG. 11 is a block diagram of a power transfer system (i.e., charging system) using a simplified wireless power interface.

FIG. 12 is a perspective view of an embodiment of a support surface for a simplified wireless power interface.

FIG. 13 is a schematic diagram of a circuit to protect a mobile device using a simplified wireless power interface from a reverse polarity electrical connection to the simplified wireless power interface.

FIG. 14 is a schematic diagram of a circuit to protect a mobile device using a simplified wireless power interface from a reverse polarity electrical connection to the simplified wireless power interface using a shunt diode.

FIG. 15 is a schematic diagram of a bridge rectifier circuit to increase orientation tolerance of a mobile device using a simplified wireless power interface to nearly 360 degrees.

FIG. 16 is a perspective view of an embodiment of a support surface for a simplified wireless power interface including magnets to assist in mobile device orientation.

FIG. 17 is a bottom view of an embodiment of a mobile device for use with a simplified power interface that includes magnets to assist in mobile device orientation.

FIG. 18 is a perspective view of an embodiment of a support surface for a simplified wireless power interface including magnets to assist in mobile device orientation and a third electrode strip to provide unique polarity regardless of mobile device orientation.

FIG. 19 is a bottom view of an embodiment of a mobile device for use with a simplified power interface that includes magnets to assist in mobile device orientation and a third electrode strip to provide unique polarity regardless of orientation.

### DETAILED DESCRIPTION OF THE PREFERRED EMBODIMENTS

An embodiment may include a method or device whereby a simplified, common interface provides power to mobile devices via electrical contact for a range of positions and orientations of the mobile device. In some embodiments, the range of positions may be automatically partially constrained mechanically such that power is transferred for all possible remaining orientations.

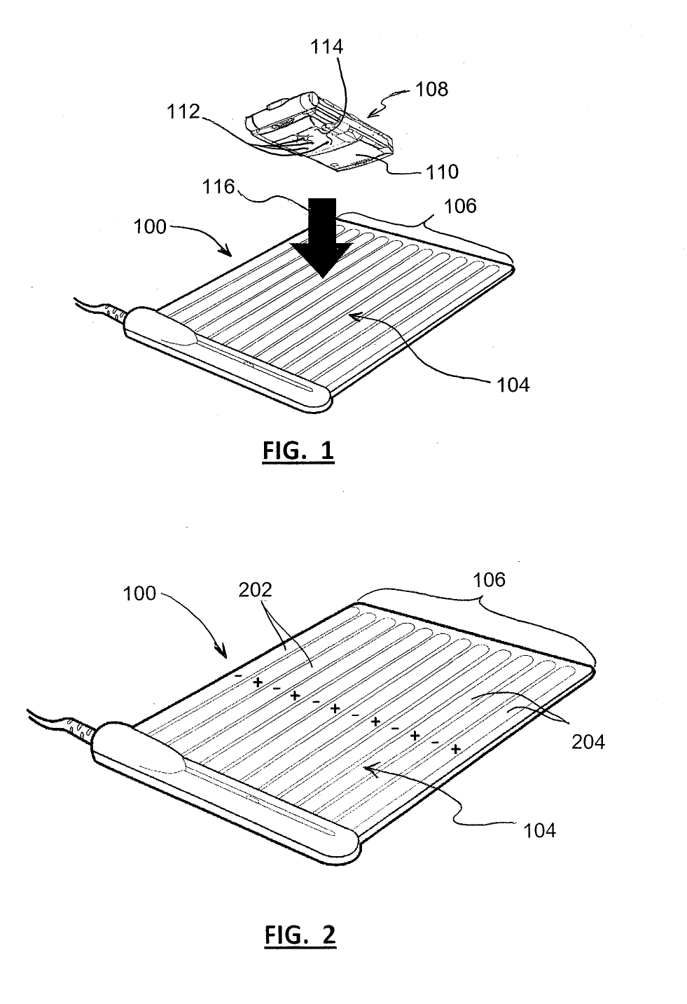

FIG. 1 is a perspective view of a wireless charging pad 100 and a mobile device 108 being placed 116 on the wireless charging pad 100. The wireless charging pad 100 receives power from a power source 102. The ultimate power source may be any available electrical power source including AC and DC power sources. Either at the charging pad 100 or before electrical power is received 102 at the charging pad 100, the power may be conditioned to meet the electrical requirements of the charging pad 100. One skilled in the art is capable of defining the proper electrical requirements for the charging pad 100 to charge desired mobile devices 108. The charging pad 100 has a surface support structure 104 containing an array of conductors 106 intended to make electrical contact with the contact points 112 on the bottom 110 of the mobile device 108. The array of conductors 106 may be arranged in an alternating pattern of positive and negative charged conductors (see disclosure with respect to FIG. 2). The bottom 110 of the mobile device 108 has many contact points 112 arranged in a pattern 114. The mobile device 108 is typically considered to be mobile, but may be any device 108 with a battery that requires charging, even if the device is not considered to be mobile.

FIG. 2 is an enlarged perspective view of a wireless charging pad 100 showing an array 106 of alternately positively 204 and negatively 202 charged contact strips 106. The wireless charging pad 100 of FIG. 2 is similar to the wireless charging pad 100 of FIG. 1. Thus, the wireless charging pad 100 is supplied power 102 to an array of conductors 106 for use to charge a mobile electronic device 108. The mobile electronic device makes contact with the support surface 104 of the wireless charging pad 100. The support surface 104 of the wireless charging pad 100 exposes the array of conductors 106 to the contact points 112 of the mobile device 108. There need to be a sufficient number of contact points 112 on the mobile device 108 arranged in a pattern 114 to ensure that at least one contact point 112 has an electrical connection with a negatively charged conductor strip 202 and at least a second contact has an electrical connection with a positively charged conductor strip 204. The mobile device 108 may need many contact points 112 to ensure proper electrical connection to the conductor array 106 of the wireless charging pad 100. As shown, the mobile device 108 has four contact points 112. Some embodiments may require five or more contact points 112 to ensure proper electrical connection between the mobile device 108 and the charging pad 100.

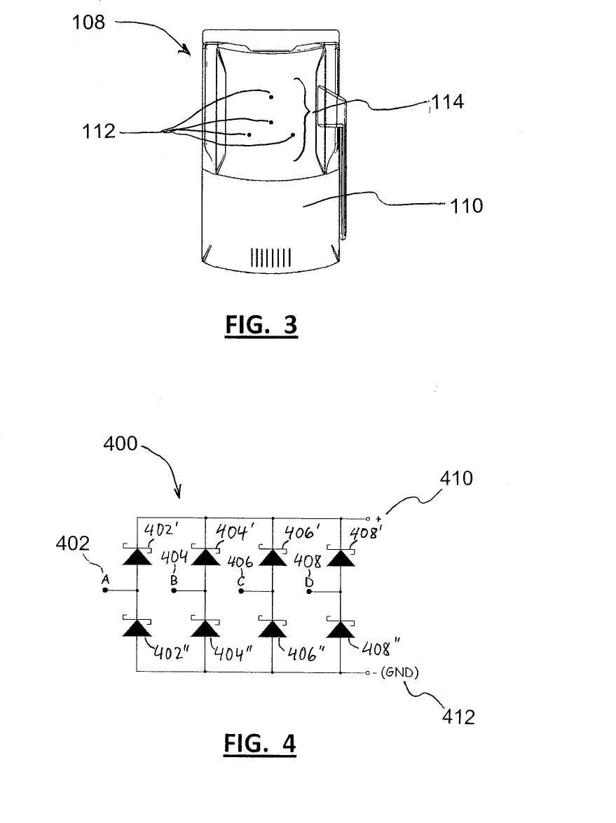

FIG. 3 is an enlarged bottom 110 view of an enabled mobile device 108 showing multiple contact points 112 arranged in a contact pattern 114. As shown, there are four contact points 112 arranged in pattern 114. The mobile device 108 of FIG. 3 may be charged by placement on the support surface 104 of the charging pad 100 described in the disclosure with respect to FIGS. 1 and 2.

FIG. 4 is a schematic diagram of a four-way bridge rectifier 400 for properly obtaining the correct electrical connection for a mobile device 108 with four contact points 112. Contact points A 402, B 404, C 406, and D 408 correspond to the four contact points 112 on the mobile device 108. The four contact points 402-408 are electrically connected as shown to a positive electrical node 410 through Zener diodes 402′-408′, respectively. The four contact points 402-408 are also electrically connected as shown to a negative/ground electrical node 412 through Zener diodes 402″-408″, respectively. The bridge rectifier 400 is electrically designed to ensure that a contact point 402-408 contacting a positive conductor 204 is properly shunted to the positive node 410 and a contact point 402-408 contacting a negative conductor 202 is properly shunted to the negative/ground node 412. One skilled in the art will recognize that other rectifier circuits and other control circuitry may be utilized to ensure proper electrical connection of the contact points 402-408 as is achieved with the bridge rectifier 400 shown.

FIG. 5 is a block diagram of a charging system having a wireless charging pad 100 with alternating conducting strips 106 and a mobile device 108 with many contact points 112 arranged in a contact pattern 114. In the system shown in FIG. 5, the AC adapter 504 is plugged into a wall plug 502. The AC adapter 504 connects to control and safety circuitry 506 which then electrically powers the support surface with an electrode/conductor pattern 508. The mobile device 510 has contact points to pickup 512 an electrical power supply from the conductors on the support surface 508. The pickup 512 of the mobile device 510 passes the electrical connection through a rectifier 514, such as the bridge rectifier 400 described in the disclosure with respect to FIG. 4. The rectifier 514 output goes through power conditioning circuitry 516 and ultimately delivers power to the target device 518.

The charging pad 100 and mobile device 108 described in the disclosure with respect to FIGS. 1-5 provides for a universal interface for mobile electronic devices 108 such that the devices 108 may be positioned at any position and orientation upon a support surface 104 of electrodes 106. To allow for ambiguity in alignment of the contact points 112 of the mobile device 108 yet still deliver power, a particular pattern 114 of contacts 112 or a large number of contacts 112 (five or more) may be required on the mobile device 108. Each of the contacts 112 is connected to one leg of a bridge rectifier 400 in order to account for the ambiguity in polarity that each of the contacts 112 may provide depending on the position and orientation of the mobile device 108 upon the support surface 104 of electrodes 106. The bridge rectifier 400 may increase the complexity, cost, and inefficiency of the charging system.

The technology of the charging pad 100 and mobile device system 108 is termed conductive in that the charging system relies on physical contact between a set of conductors 106 on a surface 104 with alternating polarity, and a set of contacts 112 on a device 108 resting on the surface 104. Power may be obtained within the device 108 by rectifying the arbitrary polarity found at each contact point 112 as described in the disclosure with respect to FIG. 4.

Power is extracted from the surface 104 of the pad 100 through two or more of the contacts 112 on the device 108. Electrical contact may be accomplished via a simple bridge rectifier as shown in FIG. 4.

For the charging pad 100/device 108 charging system described in the disclosure with respect to FIGS. 1-5, other patterns of electrodes 106 and contact points 112 are possible to attain power transfer regardless of device 108 position and orientation on the support surface 104 of electrodes 106. The charging system of FIGS. 1-5 is designed to be broadly applicable and, therefore, typically uses a nominal potential of 15V. Since many mobile devices are designed to be charged through ubiquitous USB (Universal Serial Bus) ports, which typically requires 5V. Thus, a voltage converter may be necessary in the charging system of FIGS. 1-5 for many mobile devices in order to step down the voltage appropriately. The disclosure with respect to the block diagram of FIG. 5 describes a typical application.

An embodiment may provide an interface in which the device alignment is partially mechanically constrained or in which the power transfer is guaranteed for a subset of all possible positions and orientations of devices. For a system with partial mechanical constraints of the charging devices, the number of contacts that are required on the mobile device may be reduced, thus, reducing the complexity of the rectifier circuit. In some embodiments the rectifier may be completely removed. Further a system that is more appropriate for a wide range of mobile devices that require 5V input potential may also be beneficial.

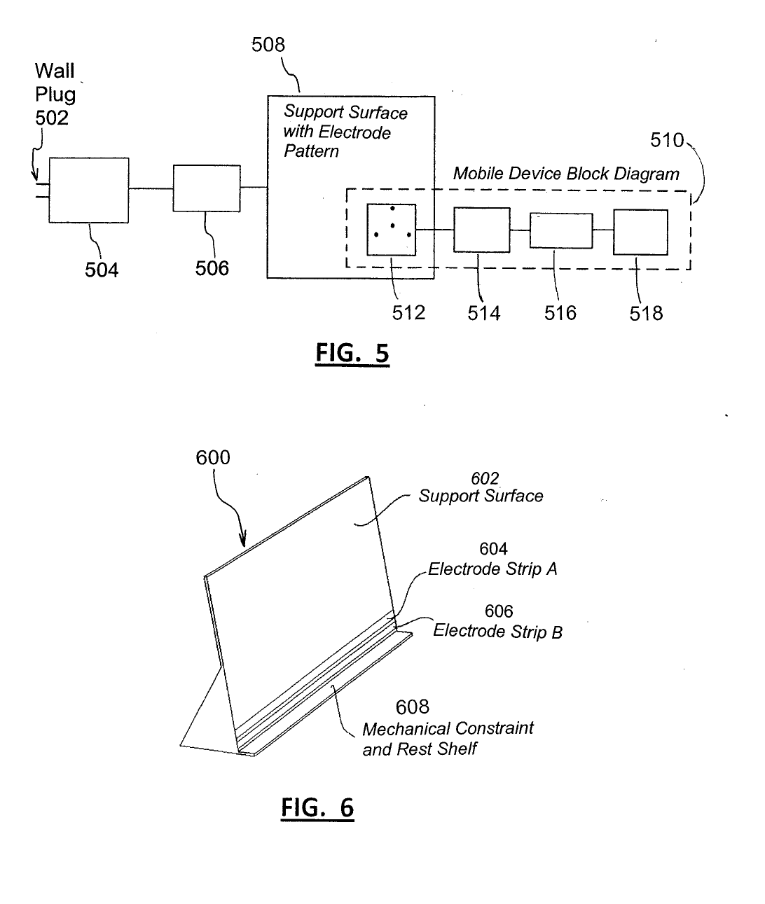

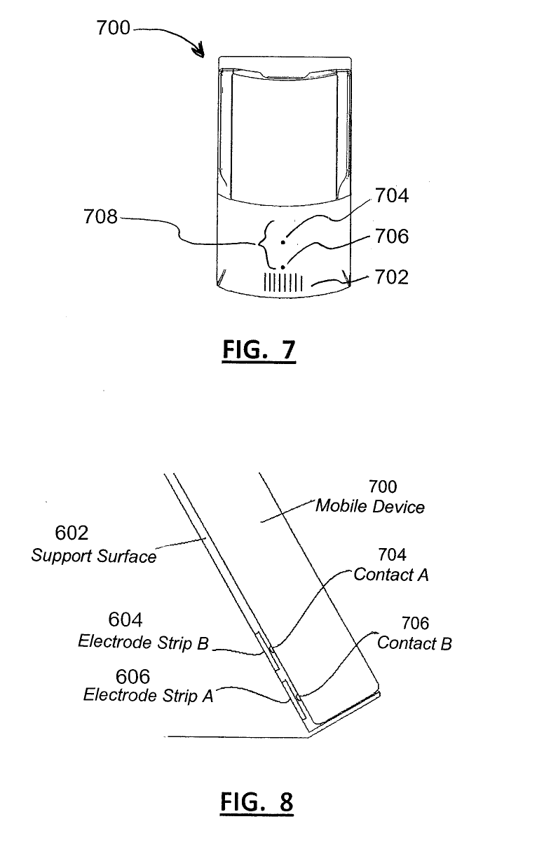

FIG. 6 is a perspective view of a simplified wireless power interface embodiment 600 that uses partial mechanical constraints to orient a mobile device. The embodiment of a simplified universal power interface 600 shown in FIG. 6 has an support surface 602 mounted vertically or nearly vertically so that a device 700 (see the disclosure with respect to FIG. 7) that rests on the simplified wireless power interface 600 will tend to slide down due to the force of gravity. A mechanical rest shelf 608 extends outward along the bottom edge of the support surface 608. A mobile device 700 may, therefore, rest against the support surface 608 and be simultaneously aligned to rest against the rest shelf 608. Accordingly, the positions of the electrical contacts 708 (see the disclosure with respect to FIG. 7) on the mobile device 700 are aligned to a predetermined position with respect to the support surface 608 such that the electrical contacts 708 make contact with electrode strip A 604 and electrode strip B 606.

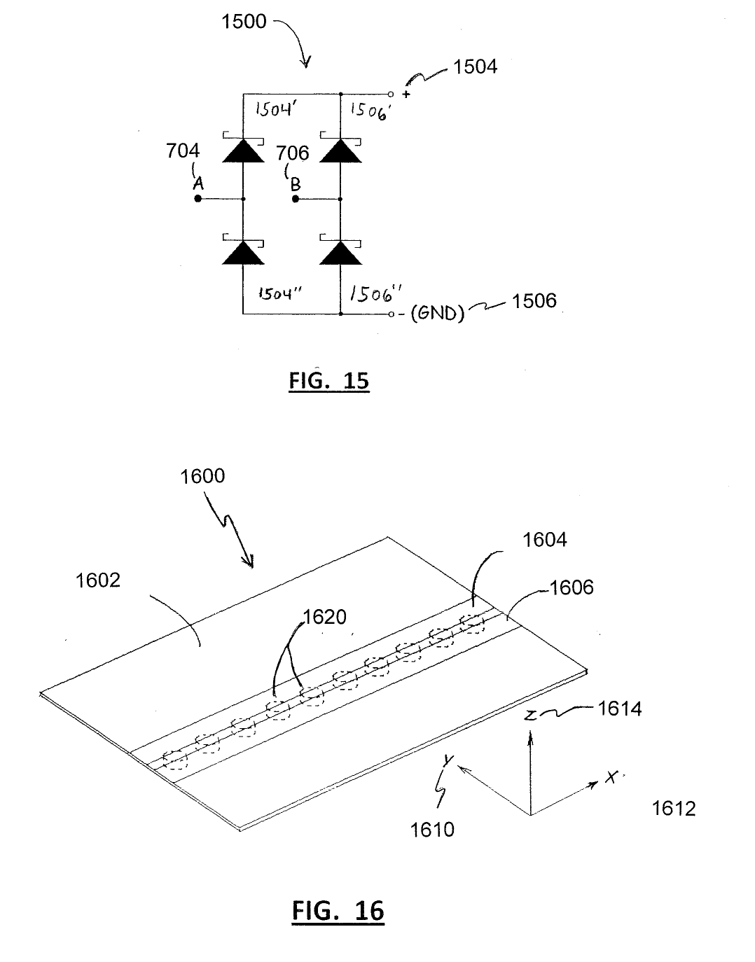

FIG. 7 is a bottom 702 view of an example power receiving device 700 with two contact points 708 for connection to a simplified wireless power interface 600. The mobile device 700 may be configured with two contact points 708 as shown instead of the 4 or more described in the disclosure with respect to FIGS. 1-5. Depending on the protection circuitry, or lack thereof, the contact points 708 may be polarity sensitive. That is, contact point A 704 may only function properly when in contact with electrode A 604 and contact point B 706 may only function properly when in contact with electrode B 708. A bridge rectifier 400 as described in the disclosure with respect to FIG. 4 may alleviate the polarity problem at an increase in system component cost as compared to a polarity sensitive solution (see also the disclosure with respect to FIG. 15).

FIG. 8 is a side view of a mobile device 700 resting on a simplified wireless power interface support surface 600. When the mobile device 700 rests against the support surface 602 and is then positioned via gravity (or some other force) against the rest shelf 608, contacts A 704 and B 706 are at predetermined distances with respect to the support surface 602 and the rest shelf 608. Ideally, the predetermined distance corresponds to the point midway up the width of electrode strips A 604 and B 606 such that electrical contact is made between electrode strips A 604 and B 606 and contact points A 704 and B 706 as shown in FIG. 8.

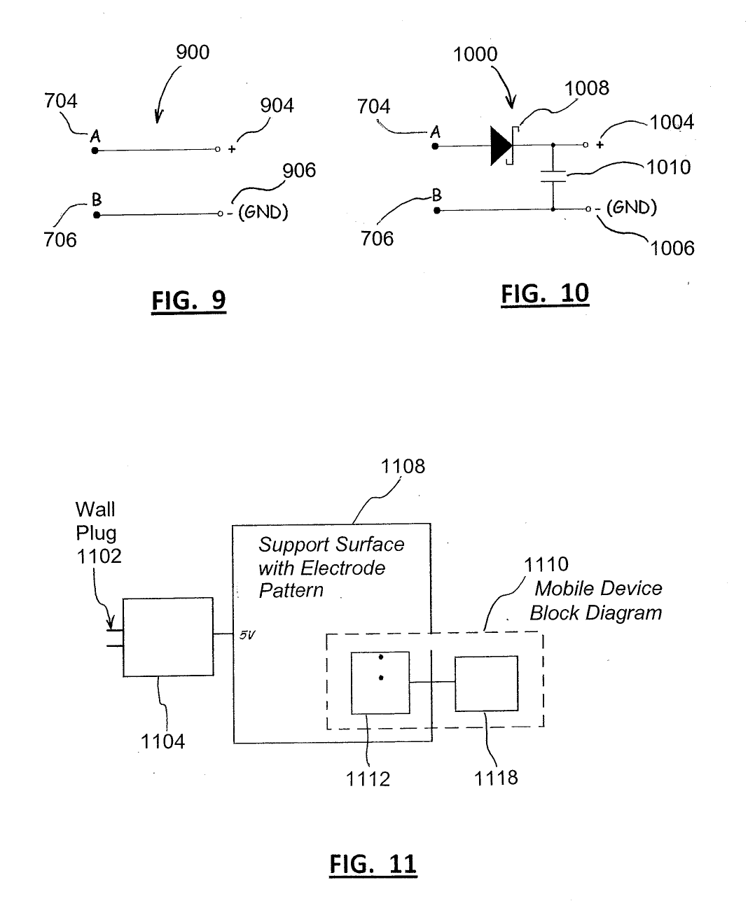

Due to the mechanical constraint of the rest shelf 608 and the placement of the contact points 708 on the mobile device 700, it may be guaranteed that when the charging circuit is closed between the support surface electrodes 604, 606 and the mobile device contacts 704, 706, the polarity is as expected. As one skilled in the art may understand, by placing the contact points 708 on an end of a device, it may be mechanically guaranteed that contact A 704 and contact B 706 may not contact either electrode strip A 604 or electrode strip B except in a single orientation as the contact points 708 would be above the electrode strips 604, 606 when the device 700 is positioned upside down or on either side with respect to the rest shelf 608. In other words, the mechanical constraint may insure that contact A 704 connects to electrode A 604, and contact B 706 connects to electrode B 606. Due to the mechanical constraint, the need for a bridge rectifier, such as those shown in FIGS. 4 and 15, is unnecessary and a simple connection such as the connection described in the disclosure with respect to FIG. 9 may be utilized with a corresponding reduction in overall component costs.

Various embodiments may permit several devices 700 side-by-side to simultaneously acquire power from the power delivery surface 602. Thus delivering a convenient wireless power system.

FIG. 9 is a schematic diagram of a simple circuit 900 for deriving power from a simplified wireless power interface 600. A mobile device 700 designed to charge on a mechanically constrained simplified wireless power interface 600 may forgo polarity correction or protection due to the mechanical constraints 608, 708 that ensure proper polarity connection between the device 700 and the simplified wireless power interface 600. Thus, an embodiment 900 may connect contact A 704 to the positive battery terminal 904 and contact B 706 to the negative/ground battery terminal 906.

FIG. 10 is a schematic diagram of a safety circuit 1000 for protecting a mobile device 700 deriving power from a simplified wireless power interface 600. The safety circuit 1000 may be used to accommodate a safety protected support surface 602. The safety protected support surface 602 may temporarily remove the electrical potential (i.e., voltage) from the surface 602 electrodes 604, 608. During the time the electrical potential is removed from surface 602 electrodes 604, 608, the power receiver in the mobile device 700 may need to have a small amount of storage capacitance 1010 to sustain the internally available mobile device 700 power supply electrical potential. As shown, the safety circuit 1000 places a Zener diode 1008 between contact point A 704 and the positive battery terminal 1004. Contact point B 706 is connected to the negative/ground battery terminal 1006. A capacitor 1010 is placed between the positive terminal 1004 and the ground terminal 1006. The safety circuit 1000 has the added benefit of preventing power from inadvertently being applied in the reverse direction (i.e., reverse polarity) such as may be done with a readily available 9V primary cell. The Zener diode 1008 protects against a closed circuit in a reverse polarity situation. The capacitor 1010 sustains the internally available mobile device 700 power supply electrical potential as described above. One skilled in the art will recognize that other circuits and other control circuitry may be utilized to protect against reverse polarity and/or to provide voltage support as is achieved with the safety circuit 1000 shown.

FIG. 11 is a block diagram of a power transfer system (i.e., charging system) using a simplified wireless power interface. A simplified support surface power supply 1108 may be implemented according to the disclosure with respect to FIGS. 6-10. To support USB compatible devices with minimal additional circuitry, the power supply voltage may be set to 5V with current limiting. The electrical potential (i.e., voltage) is so low as to be typically undetectable by a human. Further, current limiting may be considered a sufficient safety measure. Accordingly, the block diagram shown in FIG. 11 assumes 5V with current limiting for the support surface 1108 power supply.

In the block diagram of FIG. 11, the AC adapter 1104 is connected to a wall plug 1102. The AC adapter delivers 5V DC power to the support surface with electrode patterns 1108 as described in the disclosure with respect to FIGS. 6-10. The mobile device 1110 uses the two contact points (708) as the pickup 1112 for the electrical power. The pickup 1112 delivers power to the target device 1118 without the need for intervening circuitry (see the disclosure with respect to FIG. 9) or with minimal protective circuitry (see the disclosure with respect to FIG. 10).

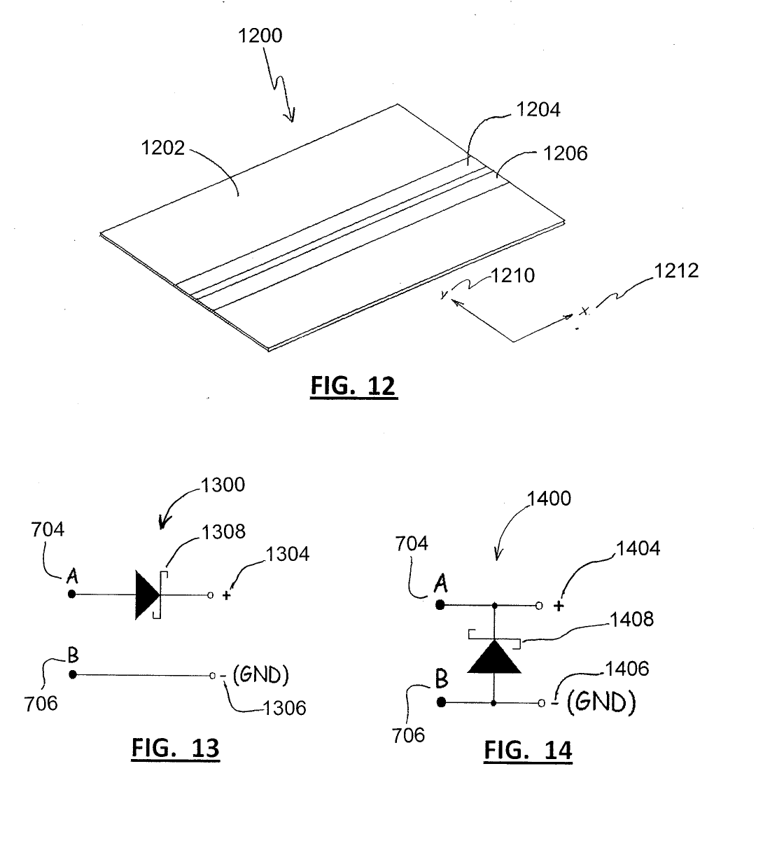

FIG. 12 is a perspective view of an embodiment of a support surface 1202 for a simplified wireless power interface 1200. For the embodiment 1200 shown in FIG. 12, a predetermined position and/or orientation of the mobile device 700 with respect to the support surface 1202 is assumed to be known to a user that is familiar with the orientation necessary for power transfer with the simplified wireless power interface 1200. When power transfer is desired, the user places the mobile device 700 on the support surface 1202 in a particular orientation and at a particular position as designated for power transfer between the support surface 1202 and the mobile device 700 via connection with electrode strip A 1204 and electrode strip B 1206 as described above for embodiments such as the embodiment 600 described in the disclosure with respect to FIG. 6. A practical design would allow for considerable positioning and orientation tolerance so that a typical user could readily arrange for power to be transferred. One skilled in the art may determine many orientation systems that may affectively provide an orientation known to a user for a mobile device 700 to be properly placed on the support surface 1202.

For instance, for an embodiment of a wireless power delivery system 1200 relying upon a predetermined range of orientations and positions of the mobile device 700 may have two strips of conductor electrodes 1204, 1206 on the support surface 1202 arranged such that the length of the conductor electrodes 1204, 1206 runs parallel to an X axis 1212 and perpendicular to a Y axis 1210. A mobile device 700, such as that shown in FIG. 7, with two contacts A 704 and B 706 on the back may derive power from the support surface 1202 provided that the mobile device 700 was roughly aligned parallel to the Y axis 1210 as shown, and roughly centered on the electrode strips 1204, 1206. The support surface 32′ may accommodate and power one or more additional mobile devices 700 set side-by-side with the first device 700, provided the additional devices were also aligned as described since the position along the X axis 1212 does not affect power transfer (so long as the mobile device rests on the support surface). It is possible that a user may place a mobile device 700 on the support surface 1200 aligned substantially 180 degrees from the desired orientation. In that case, power could inadvertently be applied to the mobile device 700 with reverse polarity.

FIG. 13 is a schematic diagram of a circuit 1300 to protect a mobile device 700 using a simplified wireless power interface 1200 (also applicable for other embodiments of the simplified wireless power interface, including 600 shown on FIG. 6, 1600 shown on FIG. 16, and 1800 shown on FIG. 18) from a reverse polarity electrical connection to the simplified wireless power interface 1200. The circuit 1300 may be used to prevent damage to the mobile device 700. The circuit 1300 connects contact A 704 to the positive battery terminal 1304 through Zener diode 1308. Contact B 706 is connected to the negative/ground battery terminal 1306. One skilled in the art will recognize that other circuits and other control circuitry may be utilized to protect against reverse polarity as is achieved with the safety circuit 1300 shown.

FIG. 14 is a schematic diagram of a circuit 1400 to protect a mobile device using a simplified wireless power interface 1200 (also applicable for other embodiments of the simplified wireless power interface, including 600 shown on FIG. 6, 1600 shown on FIG. 16, and 1800 shown on FIG. 18) from a reverse polarity electrical connection to the simplified wireless power interface 1200 using a shunt diode 1408. As with circuit 1300 shown in FIG. 13, circuit 1400 shown in FIG. 14 may be used to prevent damage to the mobile device 700 provided the diode is able to withstand the short circuit current available from the power delivery surface 1202 electrodes 1204, 1206.

In the best case with the either circuit 1300 or 1400 of FIG. 13 or 14, respectively, the mobile device 700 may receive power from the support surface 1202 for orientation angles of almost +/−90 degrees with respect to the Y axis 1210. To be clear, it is defined that zero degrees with respect to the Y axis 1210 would represent the case when the line defined by the two contact points 704, 706 is parallel to the Y axis 1210. Accordingly, 90 degrees would correspond to the line defined by the two contact points being parallel to the X axis 1212. The rotation being considered is that in the X-Y plane.

FIG. 15 is a schematic diagram of a bridge rectifier circuit 1500 to increase orientation tolerance of a mobile device 700 using a simplified wireless power interface 1200 to nearly 360 degrees. As with circuits 1300 of FIGS. 13 and 1400 of FIG. 14, the bridge rectifier circuit 1500 may also be applied with to other embodiments of the simplified wireless power interface, including 600 shown on FIG. 6, 1600 shown on FIG. 16, and 1800 shown on FIG. 18. With a slightly more complex circuit 1500 in the mobile device 700, the range of orientations may be increased to almost 360 degrees. A nearly 360 degree rotation is achieved because if the device 700 is placed substantially “upside down”—or oriented at an angle of 180 degrees +/−90 degrees, then the effect is to reverse the polarity of the potential expected on contacts A 704 and B 706. The bridge rectifier 1500 of FIG. 15 rectifies the polarity to handle the reversed polarity. The nearly 360 rotation is a function of the necessity that the two contacts 704, 706 need to be contacting different conductor electrodes 1204, 1206 from each other. One skilled in the art will recognize that other circuits and other control circuitry may be utilized to overcome reverse polarity as is achieved with the bridge rectifier circuit 1500 shown.

An embodiment with a bridge rectifier 1500 provides a wireless power delivery system 1200 that is relatively tolerant to a range of positions and orientations but cannot guarantee power delivery at all positions and orientations. Some tolerance is given up in exchange for a considerably simplified overall system. The tradeoff is minimized by the user assumption of a proper orientation and position.

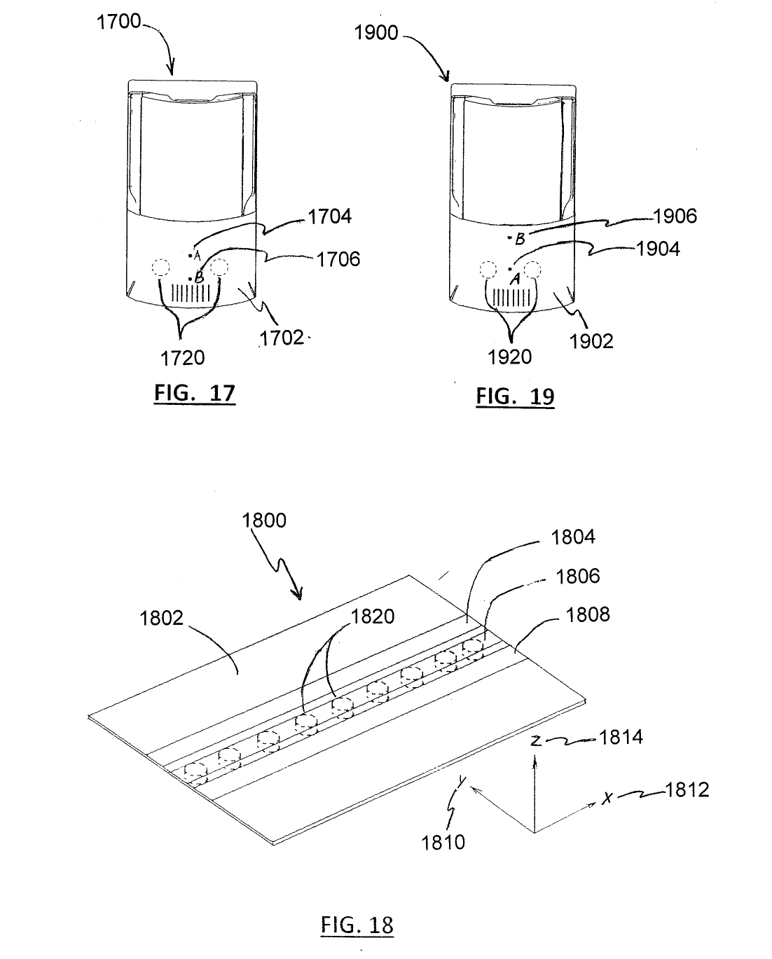

FIG. 16 is a perspective view of an embodiment of a support surface 1602 for a simplified wireless power interface 1600 including magnets 1620 to assist in mobile device 1700 orientation (see the disclosure with respect to FIG. 17). For an embodiment 1600, mechanical positioning is “softly” constrained via the use of magnets. An embodiment 1600 may have magnets 1620 (shown in phantom lines) arranged along the centerline of the gap between the electrode strips 1604, 1606. The magnets 1620 may be equally spaced a predetermined distance apart and the polarity of the magnets may be aligned in the same direction along the Z axis 1614. An embodiment 1600 may have magnets 1620 placed in the mobile device 1700 as shown in FIG. 17.

FIG. 17 is a bottom 1702 view of an embodiment of a mobile device 1700 for use with a simplified power interface 1600 that includes magnets 1620, 1720 to assist in mobile device 1700 orientation. The polarity of the magnets 1720 in the mobile device 1700 are also aligned in the same direction as the magnets 1620 on the simplified power interface 1600 and in such a way that they attract the magnets 1620 on the support surface 1602 when the contacts 1704, 1706 are facing the electrode strips 1604, 1606. The spacing between magnets 1720 on the mobile device 1720 matches the spacing of the magnets 1620 embedded within the support surface 1602. Depending on the location of magnets 1720 with relation to contacts 1704, 1706, the magnets 1620 may be located at the centerline between electrodes 1604, 1606 or elsewhere on or under the support surface 1602 as appropriate for the configuration of the magnets 1720 and contacts 1704, 1706 of the mobile device 1700. Further, more than two magnets may be used in the mobile device, but having at least two magnets permits proper orientation to a line (i.e., a line is defined by two points).

The magnet-to-magnet force is sufficient that if the mobile device 1700 were placed relatively near the desired position, the mobile device 1700 would be pulled into alignment with the two nearest magnets 1620. When engaged in this orientation the contact points 1704, 1706 would also make an electrical connection to the electrode strips 1604, 1606, thereby closing a circuit to allow power flow.

It is evident that in an embodiment of the simplified wireless power interface 1600 and mobile device 1700, the mobile device 1700 will seek one of two possible orientations denoted by zero degrees with respect to the Y axis 1610 and 180 degrees with respect to the Y axis 1610. The two orientation configurations correspond to two different voltage polarities. Therefore, it is prudent that the electrical circuit within the mobile device 1700 be protected against reverse polarity as may be accomplished via the circuits of FIG. 13, 14, or 15 (1300, 1400, 1500, respectively) as well as other possible circuits as may be recognized by one skilled in the art. Again, multiple devices 1700 may be aligned along the X axis 1612.

FIG. 18 is a perspective view of an embodiment of a support surface 1802 for a simplified wireless power interface 1800 including magnets 1820 to assist in mobile device 1900 orientation (see the disclosure with respect to FIG. 19) and a third electrode strip 1808 to provide unique polarity regardless of mobile device 1900 orientation. The magnets 1820 and devices 1900 may be aligned with the X axis 1812, Y axis 1810, and Z axis 1814 in a similar fashion as for the disclosure the embodiment 1600 described in the disclosure with respect to FIGS. 16 and 17.

FIG. 19 is a bottom 1902 view of an embodiment of a mobile device 1900 for use with a simplified power interface 1800 that includes magnets 1820, 1920 to assist in mobile device orientation and a third electrode strip 1808 to provide unique polarity regardless of orientation.

For the embodiment 1800, either of two possible orientations corresponds to a single voltage polarization. For the embodiment 1800, contact A 1904 located on the mobile device 1900 will seek electrode strip B 1806 located on the support surface 1802. Contact B 1906 on the mobile device 1900 will seek electrode strip A or C (1804 or 1808, respectively) on the support surface 1802. Since electrode A and C (1804 and 1808, respectively) are at the same potential, the resulting potential on contacts A 1904 and B 1906 will remain the same.

Since magnetic alignment is “soft,” meaning that magnetic alignment is a constraint that may be overcome with minimal force, there is still a possibility that contacts A 1904 and B 1906 will come into the various electrode strips 1804, 1806, 1808 on the support surface 1802 in such a way as to cause a reverse polarity condition within the mobile device 1900. Thus, protection such as afforded by the circuit of FIG. 13, 14, or 15 (1300, 1400, or 1500, respectively), is prudent. Again, one skilled in the art may recognize other possible circuits to provide similar protection as those discussed herein.

The benefit of the embodiment 1800, 1900 is that the required protection circuit may be simplified at the expense of an additional electrode strip 1808, and in the case of the circuit 1400 of FIG. 14, no loss occurs due to the circuit 1400. The use of a rectifier circuit 1500 may be unnecessary with the use of the additional electrode strip 1808. The embodiment 1800, 1900 provides the highest possible efficiency while still providing a simple, easy to position wireless power experience.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. A wireless power delivery system comprising:
a wireless power interface having a support surface and at least a single positive electrode strip and at least a single negative/ground electrode strip generating a predetermined voltage potential when operating;
at least one receiver device to be placed on said support surface having a first contact and a second contact, said first contact and said second contact physically spaced apart to permit separate connections for said first and said second contacts to said single positive electrode strip and said single negative/ground electrode strip; and,
a mechanical constraint system that at least partially constrains said at least one receiver orientation such that said first and said second contacts of said at least one receiver are oriented to be in contact with said single positive electrode strip and said single negative/ground electrode strip such that said predetermined voltage potential of said wireless power interface is applied between said first and said second contacts.

2. The wireless power delivery system of claim 1 further comprising a safety circuit that protects said at least one receiver device from a reverse polarity applied to said first and said second contacts by disabling the application of said predetermined voltage potential to said first and said second contacts.

3. The wireless power delivery system of claim 1 further comprising a bridge rectifier circuit that corrects polarity applied to said first and said second contacts of said at least one receiver device to properly deliver said predetermined voltage potential applied between said first and said second contacts.

4. The wireless power delivery system of claim 1 wherein said mechanical constraint system further comprises:
a support structure that places said support surface of said wireless power interface at an angle that causes said at least one receiver device to slide down said support surface when said at least one receiver device is placed on said support surface;
a rest shelf at a bottom edge of said support surface extending substantially perpendicular to said support surface far enough to catch and hold said at least one receiver device; and,
a contact placement on said at least one receiver device for said first and said second contacts that substantially permits contact between said first and said second contacts and said positive and said negative/ground electrode strips when said at least one receiver device rests on said rest shelf in a predetermined orientation.

5. The wireless power delivery system of claim 1 wherein said mechanical constraint system further comprises a predetermined and known orientation of said at least one receiver device that properly connects said first and said second contacts to said positive and said negative/ground electrode strips and requires a user to place said at least one receiver device in said predetermined and known orientation for proper operation.

6. The wireless power delivery system of claim 5 wherein said predetermined and known orientation of said at least one receiver device is substantially perpendicular to said positive and said negative/ground electrode strips.

7. The wireless power delivery system of claim 1 wherein said mechanical constraint system further comprises:
at least two receiver device magnets incorporated into said at least one receiver device with a predetermined receiver magnet orientation; and,
a series of support structure magnets incorporated into said support structure with a predetermined support structure magnet orientation that causes said at least two receiver device magnets to align with said support structure magnets to cause said first and said second contacts to properly align with said positive and said negative/ground electrode strips.

8. The wireless power delivery system of claim 7 wherein said mechanical constraint system further comprises:
at least a second positive electrode strip arranged such that said second positive electrode strip is placed on an opposite side of said negative/ground electrode strip from said positive electrode strip such that when said at least one receiver is oriented via said support structure magnets and said receiver magnets said first and said second contacts are contacting one of said positive electrode strips and said negative/ground electrode strip with a proper polarity.

9. The wireless power delivery system of claim 7 wherein said mechanical constraint system further comprises:
at least a second negative/ground electrode strip arranged such that said second negative/ground electrode strip is placed on an opposite side of said positive electrode strip from said negative/ground electrode strip such that when said at least one receiver is oriented via said support structure magnets and said receiver magnets said first and said second contacts are contacting one of said negative/ground electrode strips and said positive electrode strip with a proper polarity.
